(19) United States
(12) Patent Application Publication
(10) Pub. No.: US 2018/0179659 A1
(43) Pub. Date: Jun. 28, 2018

(54) Method for Cleaning Aluminum or Aluminum Alloy Surfaces

(71) Applicant: H&H Research & Development, LLC, Harrisburg, PA (US)

(72) Inventors: John E. Hoffman, JR., Hummelstown, PA (US); Richard A. Hoffman, SR., Harrisburg, PA (US)

(21) Appl. No.: 15/902,234

(22) Filed: Feb. 22, 2018

Related U.S. Application Data
(63) Continuation-in-part of application No. 15/364,859, filed on Nov. 30, 2016, now abandoned.
Application No. 15/364,859 is a continuation-in-part of application No. PCT/US2016/045951, filed on Aug. 8, 2016.

(51) Int. Cl. C25F 1/00; B08B 3/08; B08B 3/10

(52) U.S. Cl. CPC C25F 1/00; B08B 2220/04; B08B 3/10; B08B 3/08

(57) ABSTRACT

A method for cleaning a surface of an aluminum or aluminum alloy body of coatings, contaminants, dirt, or the like by immersing the surface in a basic aqueous electrolyte containing carbonate ions, connecting the body directly to the negative terminal of a DC current source and flowing DC current through the body. After a time, the flow of DC current is stopped and the surface is removed from the electrolyte. The surface is then rinsed off to remove the coating, dirt, contaminants, or the like from the surface. The cleaned surface may be recoated for reuse of the body

### RELATED APPLICATIONS

This application is a continuation-in-part of and claims the benefit of our co-pending U.S. patent application Ser. No. 15/364,859 “Method for Cleaning Metal and Metal Alloy Surfaces” filed Nov. 30, 2016 which is a continuation-in-part of and claims the benefit of International Patent Application PCT/US2016/045951 “Method for Cleaning Metal and Metal Alloy Surfaces” filed Aug. 8, 2016 at Attorney Docket No. 1-2310-PCT, the two above-listed priority applications each incorporated by reference as if fully set forth herein.

### FIELD OF THE DISCLOSURE

The disclosure relates generally to cleaning of metal or metal alloy surfaces, and more specifically, to electrolytic cleaning of aluminum or aluminum alloy surfaces.

### BACKGROUND OF THE DISCLOSURE

Surfaces of aluminum bodies or components must be returned to a clean, bare surface for recycling and reuse (“aluminum” as used in this specification refers to aluminum and aluminum alloys).

Aluminum wheels of trucks and airplanes, for example, may be sold with a powder coating on wheel surfaces. Powder coating is a thermoplastic or polymer coating that creates a hard finish that is tougher than conventional paints. The powder coating is applied electrostatically to the surface and then cured to form a protective skin over the surface. The powder coating, along with brake dust, road grime, oil, and other surface contaminants or coatings must be removed from the wheel before the wheel can be recycled and reused.

Cleaning metals was previously accomplished using washing equipment that applied acidic cleaning solutions or pickle liquors often having a low pH. But acids were often too aggressive on the washing equipment itself, and disposing the spent cleaning liquid was difficult and expensive. The metal cleaning industry then began using alkaline cleaning solutions in conjunction with water-soluble soaps. But disposal of the alkaline liquid again proved difficult and expensive.

The metal cleaning industry then developed electrolytic cleaning systems to overcome some of these difficulties.

For example, Riabkov et al. U.S. Pat. No. 5,981,084 incorporated by reference herein discloses use of potassium carbonate as an electrolyte for cleaning metal objects. In the '084 patent, the temperature, pH, thermal conductivity, and other factors of the electrolyte are set within narrow bounds to allow formation of gas bubbles in the electrolyte that will actually “micro-melt” the metal for cleaning. The bubbles are streamed against the metal and conduct a plasma spark to the metal for micro-melting.

The inventors' U.S. Pat. No. 6,203,691, U.S. Pat. No. 6,264,823, and US Patent Application Publication 2002/0157964 (referred to collectively herein as the “Hoffman patent documents”, each of which are incorporated by reference as if fully set forth herein) disclose electrolytic cleaning of metals particularly useful for cleaning ferrous bodies such as shopping carts having steel frames. The cleaning methods disclosed in the Hoffman patent documents did not rely on formation of gas bubbles and are much easier to set up and use than is the cleaning method disclosed in the '084 patent.

The surface to be cleaned is wetted by the electrolyte and DC current is passed through the body. The electrolyte is a basic aqueous electrolyte that may include disodium phosphate and sodium bicarbonate. The cleaning methods disclosed in the Hoffman patent documents, although well-suited for many cleaning needs, do not efficiently remove powder coatings or other specialized coatings found on aluminum wheels or other aluminum bodies.

Conventional methods to remove powder coatings from the surfaces of aluminum include use of specific solvents, heating the powder coating to high temperatures, or abrasive blasting. Methylene chloride, benzyl alcohol, and acetone are generally effective solvents for removing powder coating from aluminum surfaces. Alternatively, the body may be placed in an oven heated to a temperature of between 300 degrees Centigrade −450 degrees Centigrade for several hours to burn off the powder coating. Abrasive blasting mechanically removes the powder coating.

Conventional methods to remove powder coatings have disadvantages. Some solvents are suspected carcinogens. Heating components to hundreds of degrees Centigrade may warp the body or may adversely impact heat treatments of metal alloys. Abrasive blasting may remove metal as well as damage or roughen the surface. And conventional cleaning methods either take a long time to remove the powder coating or require extensive manual labor and handling.

Thus there is a need for an improved method for electrolytic cleaning of aluminum bodies that can efficiently remove powder coatings and other surface coatings or contaminants while still being relatively easy to apply and that uses inexpensive, environmentally friendly, and non-hazardous materials.

### SUMMARY OF THE DISCLOSURE

Disclosed is a method for electrolytic cleaning of surfaces of aluminum components or bodies well suited for removing powder coatings as well as other surface coatings and contaminants. The electrolyte used in possible embodiments of the disclosed method is inexpensive, environmentally friendly, and non-hazardous.

A method for cleaning an aluminum surface of an aluminum body in accordance with the present disclosure includes the steps of:

(a) wetting the surface of the body with an aqueous electrolyte, the electrolyte comprising a dissolved carbonate salt and having a pH greater than 7;

(b) attaching the body to the negative terminal of a DC current source and flowing DC current through the body concurrently with step (a), the flow of DC current sufficient to thereby coat the wetted surface with a coating of additional material; and

(c) stopping the flow of the DC current after performing step (b) and removing the additional coating from the surface, thereby cleaning the surface.

The surface of the body in embodiments of the disclosed method can be wetted by immersing the body in the electrolyte or by spraying the body with the electrolyte.

Contaminants or coatings that can be cleaned from surfaces of aluminum bodies in accordance with the disclosed method include, but are not limited to, carbonization, surface powder coatings, paints, petroleum based or hydrocarbon (organic) based materials, environmental contaminants including dirt, soil, dust, or smut.

The inventors have found that applying a DC current with the aluminum body attached to the negative terminal of the DC current source or power supply deposits a coating of an additional material on the portion of the body wetted by the electrolyte.

The inventors have first-hand, hands-on experience using the cleaning methods disclosed in the Hoffman patent documents in cleaning thousands upon thousands of steel grocery carts and steel engine parts. The inventors never saw evidence of an additional material coating as described herein being deposited on any if the steel grocery carts and steel engine parts while being cleaned or after cleaning using the cleaning methods disclosed in the Hoffman patent documents. Parts removed from the electrolyte after cleaning were sprayed with water to remove loose debris. Debris removed by the cleaning process would remain in the electrolyte (unless removed by filtering or the like) so it was not surprising that loose debris removed by the electrolytic cleaning might adhere to objects being removed from the electrolyte. But the loose debris was not the additional material coating described herein.

Without being bound by or limited to any theory or explanation, the inventors herein theorize as to the creation and cleaning benefits of the additional material coating. The additional material is not believed to be generated by either reduction or oxidation of the aluminum forming the body but is believed to be created by oxidation of the carbonate ions in the electrolyte. The oxidized carbonate ions form the coating on the portion of the body immersed in or wetted by the electrolyte. The additional material coating is visible as a substantially gray to black coating that covers the entire outer surface of the portion of the body immersed in or wetted by the electrolyte. The additional material coating appears to physically or chemically break down coatings and contaminants (including but not limited to powder coatings) that are on the immersed or wetted surfaces without harming the body, and without removing or otherwise affecting metal or metal alloys of the body.

The additional material coating is generated from the application of DC current to the aluminum body while the body is being wetted by the electrolyte. The additional material coating is not generated merely by placing the body in the electrolyte, nor is it caused by debris or contaminants removed by cleaning. An entire clean aluminum truck wheel treated by the electrolytic cleaning method disclosed herein using a clean electrolyte resulted in the same additional material coating being present on the entire wheel when the wheel was removed from the electrolyte.

The electrolyte also darkens with creation of the additional material, but the darkening of the electrolyte does not appear to adversely impact the cleaning process.

After removal from the electrolyte, the additional material coating can be rinsed off with water. Rinsing off the additional material also removes the contaminants on the immersed surfaces (including powder coatings if present), resulting in clean surfaces suitable for recycling.

The additional material coating formed on aluminum objects wetted by the electrolyte while being cleaned by the method disclosed herein was unexpected and a surprise. Electrolysis of iron rust converts the rust to a black chemical compound (believed to be iron or iron oxides) but iron rust is not found on aluminum bodies.

It was also surprising the additional material coating could be rinsed off the body with a low pressure water spray upon removal from the electrolyte to leave a clean metal surface. In a possible embodiment of the disclosed method, a low pressure water jet is used to rinse off the additional material. “Low pressure water jet” as used herein means use of a water jet in which the pump pressure is less than 5,000 psi (340 bar). Rinsing using a low pressure water jet of about 2,000 psi has been found effective in embodiments of the disclosed method in removing the additional coating and, along with the additional coating, powder coatings and other contaminants without damage to the body.

The carbonate salt must be dissolvable in water. Preferred carbonate salts are potassium carbonate and sodium carbonate, the most preferred is potassium carbonate.

The electrolyte is a basic electrolyte. The electrolyte in embodiments may be mildly alkaline or may be highly alkaline. The electrolyte in embodiment may have a pH greater than 7, or a pH from greater than about 8 to not more than about 13, or a pH of about 11.

The electrolyte may be maintained at a temperature not less than about 70 degrees Fahrenheit to not more than the boiling point of the electrolyte, or may be maintained at between not less than about 150 degrees Fahrenheit and the boiling point of the electrolyte.

The DC current applied to the body in embodiments may be about 200 amperes or greater, may be between about 200 amperes and about 5000 amperes, and may be about 1000 amperes.

The DC current applied to the body in embodiments may be applied for between about 2 minutes and about 15 minutes, may be applied for between about 3 minutes to about 5 minutes, and may be applied for about 5 minutes.

The DC voltage applied to the body to induce current flow in embodiments may be less than or equal to about 200 volts, and the applied DC voltage may be equal to or more than about 3 volts.

The additional material may in embodiments of the disclosed cleaning method be rinsed off the body preferably no more than about 15 minutes after removal from the electrolyte, and is preferably rinsed off not more than about 10 minutes after removal from the electrolyte, and most preferably is rinsed off not more than about 5 minutes after removal from the electrolyte.

The additional material may in other embodiments of the disclosed cleaning method be removed by ultrasonic cleaning. The body is removed from the electrolyte and placed in a tank of an ultrasonic cleaner preferably containing an aqueous cleaning solution. The ultrasonic cleaner may be a Model JTS-1018 ultrasonic cleaner manufactured by Skymen Cleaning Equipment Shenzhen Co., Ltd., Guangdong, China or equivalent.

It has been observed that the additional material coating hardens after removal from the electrolyte and after time may become so hard that it becomes relatively difficult to remove. The sooner after the body is removed from the electrolyte that removal of the additional material is initiated, the easier it is to remove the additional material. It has been found that removing the additional material is preferably initiated within about 15 minutes after stopping the DC current.

A suitable source of DC current for use in embodiments of the disclosed methods includes, but is not limited to, the Model No. 43p1-00 im-048 rectifier manufactured by Process Electronics Corp, Mt Holly, N.C. 28120 USA. This rectifier can provide 1000 DC amperes at 48 amperes with a continuous duty cycle.

Powder coatings have been successfully removed from motor vehicle wheel hubs and rims made from aluminum, steel, and manganese. Other bodies that have been successfully cleaned using the disclosed method of cleaning include cast iron and stainless steel bodies.

The disclosed method for cleaning has a number of advantages. Potassium carbonate and sodium carbonate electrolytes are inexpensive and environmentally friendly. Food grade potassium carbonate and food grade sodium carbonate are available and are non-toxic. Rinsing the bodies to remove the additional coating and contaminants can be automated, is not labor intensive, and can generate high production rates of cleaned bodies as compared to conventional cleaning methods (particularly when removing powder coatings).

A further advantage of the disclosed method for cleaning when cleaning aluminum or aluminum alloy bodies is that the body is not discolored after cleaning. Conventional cleaning of aluminum or aluminum alloy bodies in a strong alkaline solution may discolor the body. Rubin et al. U.S. Pat. No. 4,457,332 for example suggests adding metasilicate salt to a strongly basic aqueous solution to avoid discoloration of aluminum bodies. The inventors have found that aluminum bodies cleaned in accordance with the disclosed method do not discolor even when cleaned using a highly alkaline aqueous electrolyte that includes only carbonate salts.

The disclosed method, although in embodiments using potassium carbonate as the basis for the electrolyte, unlike the cleaning method disclosed in the Riabkov et al. '084 patent does not rely on the formation of gas bubbles or the generation of plasma sparks to provide effective cleaning.

Other objects and features of the disclosure will become apparent as the description proceeds, especially when taken in conjunction with the accompanying drawing sheets illustrating one or more illustrative embodiments.

### BRIEF SUMMARY OF THE DRAWING

FIG. 1 is a schematic view of a metal alloy wheel immersed in an electrolyte for cleaning in accordance with an embodiment of the disclosed method of cleaning.

FIG. 2 is an enlarged view of a portion of the wheel shown in FIG. 1.

### DETAILED DESCRIPTION

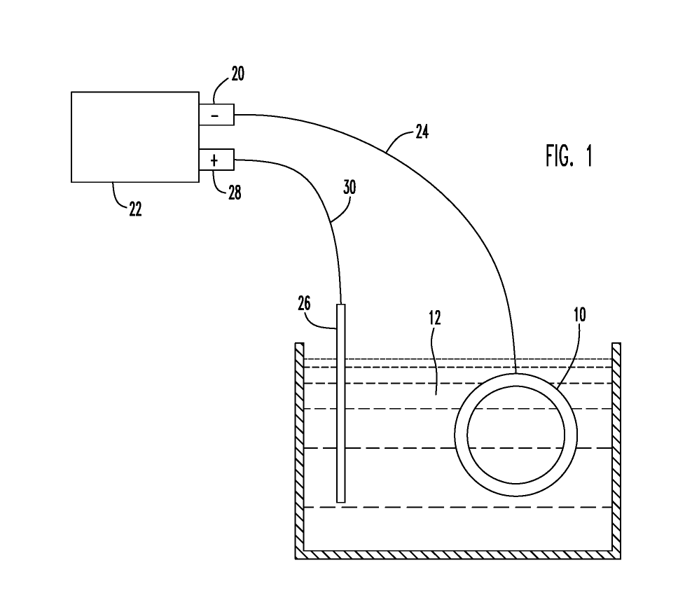

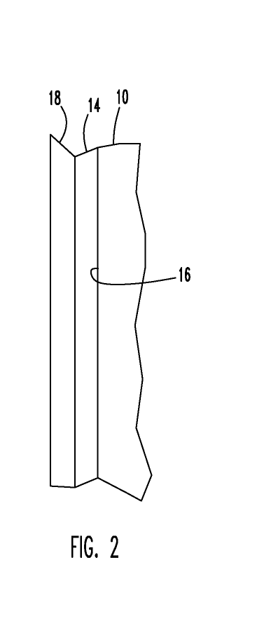

FIG. 1 illustrates a used truck or airplane wheel 10 totally immersed in an electrolyte 12 for cleaning in accordance with the disclosed method. The wheel 10 is a conventional aluminum wheel that has a powder coating 14 on an external surface 16 of the wheel. See FIG. 2. It is desired to remove the powder coating 14 and surface contaminants 18 on the powder coating from the surface 16 to enable recycling and reuse of the wheel.

The wheel 10 is connected electrically in series to the negative terminal 20 of a DC current source 22 by a conductor 24. A steel or iron electrode 26 is also immersed in the electrolyte 12 and is connected in series to a positive terminal 28 of the current source 22 by a conductor 30. The wheel 10 and the electrode 26 are electrically connected by the electrolyte 12.

The illustrated electrolyte 12 is an aqueous basic electrolyte formed by dissolving only potassium carbonate (K₂CO₃) in water. The potassium carbonate is preferably food-grade potassium carbonate.

The pH of the electrolyte is about 11. The temperature of the electrolyte is about 130 degrees Fahrenheit.

In the illustrated embodiment the wheel 10 is immersed into a 200 gallon bath of electrolyte 12.

The DC current source 18 is energized and flows 1000 amperes of DC current from the negative terminal 16, through the wheel 10 and to the electrode 26, and back to the positive terminal 22.

The current source 18 is energized and supplies the 1000 ampere current through the wheel 10 continuously for five minutes. The current source 18 is then shut off and the wheel 10 is removed from the electrolyte 12.

While the DC current is flowing through the wheel 10, an additional layer of material is deposited on wetted surfaces of the wheel 10. The electrolyte 12 also darkens. It has been found that the wheel 10 does not appreciably heat while the DC current is flowing. It may even be necessary to heat the electrolyte 12 to maintain a desired electrolyte temperature while the DC current is flowing.

In the illustrated embodiment it is not necessary to treat the electrolyte in response to the electrolyte darkening. Additional potassium carbonate and/or water may be added to the electrolyte to maintain the desired pH. The electrolyte may be filtered in a conventional manner to remove dirt, soil, or other contaminants introduced into the electrolyte by the bodies being cleaned.

After the current source 18 is shut off, the wheel 10 is removed from the electrolyte 12. The wheel 10 is then rinsed or otherwise cleaned using water or water and soaps or detergents to remove the additional material deposited on the wheel.

The wheel 10 may be rinsed with a low pressure water jet spray to remove the additional material deposited on the wheel 10. In the illustrated embodiment the wheel 10 is sprayed with a 2000 psi water jet spray not more than 5 minutes after removal of the wheel from the electrolyte.

The jet spray also removes the powder coating 14 and the contaminants 18 from the wheel surface 16. After rinsing, the wheel 10 has a clean wheel surface 16 capable of accepting application of a new powder coating and/or alternative surface coatings.

Alternatively, ultrasonic cleaning may be used to remove the additional material deposited on the wheel 10. With ultrasonic cleaning, the wheel 10 is removed from the electrolyte and then immersed in a liquid in which high frequency sound waves agitate the liquid for cleaning. The liquid is preferably an aqueous solution containing a cleanser compatible with aluminum. Examples of ultrasonic cleansers for cleaning aluminum that can be adapted for use with the disclosed method include TRANSBRITE™ ultrasonic cleaning liquid solution distributed by Allen Woods & Associates, Arlington Heights, Ill., PELCO KLEENSONIC™ CDC ultrasonic cleaning solution distributed by Ted Pella, Inc., Redding, Calif. 96049, and equivalents.

Ultrasonic cleaning is itself conventional and so will not be described in further detail. The inventors have found that ultrasonic cleaning at 25 kHz frequency has provided good results in removing the additional material as well as removing powder coating after the electrolytic cleaning if originally present.

After cleaning the wheel 10 is dried. The wheel 10 may then be powder coated or otherwise coated or painted for return to the aftermarket and reuse.

In alternative embodiments of the disclosed method, some, but not all, surfaces of the metal or metal alloy body require cleaning. In such embodiments, the body may only be partially immersed in the electrolyte 12 if total immersion is not required to wet the surfaces to be cleaned.

In other alternative embodiments of the disclosed method, surfaces to be cleaned may be wetted by spraying electrolyte on the surfaces to be cleaned instead of being wetted by immersion in a tank. The electrolyte spray must electrically complete the circuit in the same manner as the electrolyte in the tank and must conduct sufficient DC current to create the additional material coating.

In alternative embodiments of the disclosed method, some, but not all, surfaces of the metal or metal alloy body require cleaning. In such embodiments, the body may only be partially immersed in the electrolyte 12 if total immersion is not required to wet the surfaces to be cleaned.

In other alternative embodiments of the disclosed method, surfaces to be cleaned may be wetted by spraying electrolyte on the surfaces to be cleaned. The electrolyte spray must electrically complete the circuit from the body to the electrode as previously described and must conduct sufficient DC current to create the additional material coating.

In a further alternative embodiment of the disclosed method, trisodium phosphate (TSP) was added to the potassium carbonate based electrolyte and wheels similar to the wheels 10 were cleaned using different concentrations of trisodium phosphate in the electrolyte.

A TSP concentration of 1% or less (calculated as the weight of TSP divided by the weight of the potassium carbonate in the electrolyte and expressed as a percentage) had no appreciate effect on the cleaning of the wheel.

A TSP concentration of 5% had a positive effect, increasing the shine of the cleaned wheel, but the shine would not be considered very bright.

A TSP concentration of 50% resulted in good brightness of the cleaned wheel.

A TSP concentration of 100% (equal weights of TSP and potassium carbonate) had the best brightness.

It is contemplated that bodies may be cleaned by automating the disclosed method. For a nonlimiting example, metal or metal alloy bodies to be cleaned may be conveyed to an electrolysis station for immersion in or wetting with the electrolyte and application of DC current. Application of the DC current may stop after a predetermined time, or if a computerized optical monitoring system determines that the surface of the body has been adequately coated with the additional material to end application of DC current.

After the application of DC current stops, the body is moved from the electrolysis station to a rinse station for rinsing. The electrolyte is continuously filtered to remove contaminants in the electrolyte. The pH, temperature, and volume of electrolyte is monitored and maintained within predetermined limits by an automatic control system (not shown).

Features recited in a claim may, in embodiments of the disclosed method, be found in combination with features recited in the claims.

While one or more embodiments have been disclosed and described in detail, it is understood that this is capable of modification and that the scope of the disclosure is not limited to the precise details set forth but includes modifications obvious to a person of ordinary skill in possession of this disclosure and also such changes and alterations as fall within the purview of the following claims.

What is claimed is:

1. A method for cleaning a surface of an aluminum or aluminum alloy body, the method comprising the steps of:
(a) wetting the surface of the body with an aqueous electrolyte, the electrolyte comprising dissolved potassium carbonate and having a pH generated by the dissolved potassium carbonate greater than 7;
(b) connecting the body to a negative terminal of a DC current source and flowing DC current from the current source through the body concurrently with step (a), the flow of DC current being not less than 200 amperes; and
(c) stopping the flow of the DC current after flowing the DC current for not less than 2 minutes.

2. The method of claim 1 further comprising the step of:
(d) rinsing the surface with water after stopping the flow of DC current.

3. The method of claim 1 wherein step (b) comprises the step of flowing DC current for a sufficient length of time to coat the wetted surface with a coating of additional material.

4. The method of claim 3 comprising the step of:
(d) removing the coating of additional material from the body.

5. The method of claim 1 wherein the electrolyte has a pH of between about 8 and about 13.

6. The method of claim 5 wherein the electrolyte has a pH of about 11.

7. The method of claim 1 wherein the electrolyte comprises dissolved trisodium phosphate.

8. The method of claim 7 wherein the trisodium phosphate is present in the electrolyte at a concentration of between 5% and 100% weight percent of the dissolved potassium carbonate.

9. The method of claim 1 wherein step (b) comprises the step of:
flowing DC current of between about 200 amperes and about 5000 amperes.

10. The method of claim 0 wherein step (b) comprises the step of flowing DC current of about 1000 amperes.

11. The method of claim 1 wherein step (a) comprises maintaining the electrolyte wetting the surface at a temperature of no less than about 70 degrees Fahrenheit.

12. The method of claim 11 wherein step (d) comprises the step of maintaining the electrolyte at a temperature of no less than about 150 degrees Fahrenheit.

13. The method of claim 1 wherein step (b) comprises the step of continuously flowing the DC current through the body for not less than about 3 minutes and not more than about 30 minutes.

14. The method of claim 1 wherein step (b) comprises the step of applying a DC voltage of between about 3 volts and 200 volts to the body while flowing the DC current through the body.

15. The method of claim 1 comprising the step of:
(d) rinsing the surface with a low pressure water spray after stopping the flow of DC current.

16. The method of claim 15 wherein step (d) comprises the step of rinsing the surface with the low pressure water spray no later than about 15 minutes after stopping the flow of DC current.

17. The method of claim 1 wherein the body has a surface coating to be cleaned from the surface, the method comprising the step of:
(d) rinsing the surface coating off the surface with water after stopping the flow of DC current.

18. The method of claim 17 wherein the surface coating is a powder coating.

19. The method of claim 1 wherein the body is a wheel rim or a wheel hub of a motor vehicle.

20. The method of claim 1 comprising the steps of:
(d) sequentially cleaning a plurality of aluminum or aluminum alloy bodies in the electrolyte by performing steps (a), (b), and (c) for each body over a period of time;
(e) maintaining the pH of the electrolyte greater than 7 for the entire period of time; and
(f) maintaining the temperature of the electrolyte at or above 70 degrees Fahrenheit for the entire period of time.

21. The method of claim 1 wherein step (a) comprises the step of immersing the body entirely or at least partially into a tank holding the electrolyte.

22. The method of claim 1 wherein step (a) comprises the step of spraying the electrolyte on the surface.

23. The method of claim 1 comprising the steps of:
(d) drying the body after cleaning, and then
(e) coating the surface with a powder coating or other surface coating after drying the body.

24. The method of claim 1 comprising the step of:
(d) ultrasonic cleaning the body after stopping the flow of DC current.

25. The method of claim 1 wherein step (d) comprises ultrasonic cleaning at a frequency of 25 kHz.
